(19) United States
(12) Patent Application Publication
(10) Pub. No.: US 2003/0007516 A1
(43) Pub. Date: Jan. 9, 2003

(54) System and method for the application of a statistical multiplexing algorithm for video encoding

(76) Inventors: Yuri Abramov, Holon (IL); Micha Waldman, Or-Yehuda (IL); Hanoch Magal, Mazkeret Batia (IL); Amichay Amitay, Rishon-LeZion (IL); Reuven Ianconescu, Neve-Monoson (IL); Peretz Meron, Tel-Aviv (IL)

Correspondence Address: Edward Langer, PAt. Atty., c/o Landon & Stark Associates, One Crystal Park Suite 210, 2011 Crystal Drive, Arlington, VA, 22202, US

(21) Appl. No.: 09/899,159

(22) Filed: Jul. 6, 2001

(51) Int. Cl. H04J 3/04

(52) U.S. Cl. 370/535; 370/477

(57) ABSTRACT

A system and method are provided for statistical-multiplexing, comprising a multi-criteria optimization algorithm for video bit stream control, and an alignment of average video bit-stream rates with treatment priorities of cascaded multiplexer's inputs. The first criterion is a grouping of the encoders in accordance with content recipient's wishes. The second criterion involves adjusting the proportions of the average bit rates of the bit streams, wherein these proportions are represented in the form of integer-to-integer fractions, in accordance with the calculated optimal scanning arrays of a plurality of said cascaded multiplexers. The third criterion involves a definition of different bit-rate ranges for different groups of encoders and maintaining the average bit rates for each group of encoders according to flexible bit rate ranges, thereby providing the adjusting of the proportions of the average bit rates to be in said form of integer-to-integer fractions, providing a laminar bit stream finally combined as the output of the last of the cascaded multiplexers.

### FIELD OF INVENTION

The invention relates generally to the processing of video signals, and more particularly to encoding and decoding of video signals according to a novel statistical-multiplexing algorithm.

### BACKGROUND OF THE INVENTION

Digital video applications are enjoying vast commercial demand for the mainstream cable and broadcast television market. With the steadily declining cost of Motion Picture Experts Group (MPEG)-2 compression hardware and general-purpose computer platforms, streaming video has become increasingly popular among video broadcasters. Among other advantages, MPEG-2 digital video files can be easily archived, rapidly distributed, and promptly manipulated to fit the application requirement. Equally important, MPEG-2 transport streams can be packaged with other digital video sources and analog program content to create custom lineups.

For most cable operators, the decision is whether to encode their own streams or use existing ones from satellite distribution networks, wide, or local-area networks. As wide-area distribution of prepackaged programming content becomes more readily available, using existing MPEG-2 transport streams in video programming continues to become more efficient and cost-effective. In many cases, cable operators have the freedom to select from a wide variety of program sources to fit their specific demographic and time-based programming needs. For these reasons, MPEG-2 based video/audio and data programming is currently the preferred choice of most cable operators and one of the simplest ways to make the conversion to digital video.

As with most emerging technologies, effectively manipulating MPEG-2 video comes with its share of challenges. Key considerations for cable operators in deciding how best to add MPEG-2 video technology to their operations include:

maximizing the use of legacy, i.e., existing cable plant equipment;

combining programming from a variety of digital and analog sources (satellite-based national services, locally encoded content, and video servers containing movies) to create a custom program lineup; and

protecting their investment in digital cable head-end equipment to accommodate the rapid advance of technology.

MPEG-2 digital video programming streams from satellites, encoders, or video servers generally contain multiple channels of compressed video, audio, and data streams all running at variable bit rates (VBR's). These channels are multiplexed to form a single constant-bit-rate (CBR) stream or multiplex. As such, the bit rate of each constituent channel of a multiple-channel stream works in concert with the bit rates of the other channels in the stream. For example, if one channel has a higher share of the total multiplex bandwidth, other channels will correspondingly have an aggregate lower share of the multiplex bandwidth. The bandwidth allocation among different channels is not static, but is dynamically adjusted over time, depending on the relative complexity of each channel. This process is called statistical multiplexing (stat-mux).

Statistical multiplexing is a highly efficient method to make the best use of a given transponder or cable spectrum bandwidth while maintaining near-constant video quality across all video channels. However, it also presents a significant technical challenge when a custom channel lineup must be created from multiple statistically multiplexed bit streams. Specifically, when multiple channels are extracted from multiple independently statistically multiplexed bit streams, they must be combined to form a new statistically multiplexed bit stream. In this case, the peak bit rates of the various source streams could exceed the total fixed bit rate for the output stream. Because each bit stream may have been generated as part of its own statistical multiplexing process, its individual bandwidth allocation is no longer relevant to the new multiplex.

The key technical challenge then for cable operators wanting to manipulate an MPEG-2 stream to create a custom lineup is combining the various VBR sources to construct a new multiplex without exceeding the fixed bandwidth of the output channel. Yet staying within the bandwidth constraints is not the only challenge in building a custom lineup. To fully capture its potential ad revenue, the cable operator must also combine MPEG-2 digital and analog sources to efficiently maximize the available output bandwidth.

In a typical case, for example, a cable operator purchases a prepackaged eight-channel MPEG-2 video transport stream, but two channels in the stream duplicate programs in its existing analog tier. Eliminating the duplicate channels from the digital multiplex requires blocking the channels. Doing so, however, leaves the cable operator with only six digital channels, with the extra bandwidth going unused.

A better solution would be to replace the two unwanted channels with two new channels from other digital sources, including satellite-based national services, locally encoded content, and video servers containing movie content. This approach, known as video program grooming, not only maximizes the bandwidth utilization of the existing cable equipment, but also preserves the ad revenue corresponding to that bandwidth. The problem with replacing the two channels with two new channels consisting of numerous VBR sources is that the bit rates are constantly changing.

Advertising is a primary revenue-generating activity for cable operators. Fees from ad insertion alone can represent as much as 20 percent of total revenue. By adjusting the multiplexed content for inclusion of local cable advertising, advertisers can maximize revenue by targeting advertisements toward specific demographic regions or time periods.

Video on demand (VOD) is one of the most popular applications of MPEG-2 video compression technology. In VOD applications, bit-rate reduction and statistical remultiplexing of video streams are introduced by a video server. This process increases the number of digital video programming channels multiplexed into a single 6-MHz bandwidth, and typically delivers a 30-percent improvement in network utilization.

High definition television (HDTV) signals require 19 Mbps, a fraction of the commonly used 64 quadrature amplitude modulation (QAM) channel, but there is no way to use the other 8 Mbps of the QAM channel without statistically remultiplexing. Remultiplexing allows the operator to combine standard-definition television (SDTV) programs with high-definition television (HDTV) programs.

In typical broadcast systems, such as in direct broadcast satellite (DBS) applications for cable television, multiple video programs, such as movies, are encoded in parallel for purposes of transmission, and the digitally compressed bitstreams are multiplexed onto a single, constant bit rate channel. The simplest approach to this multiprogram encoding is to divide the available channel bandwidth equally among all programs. This method has the disadvantage that at any instant in time, the resulting quality of the video programs is uneven because of the different scene content of the programs and changes of scene content over time. To achieve equal video quality, i.e., equal distortion for all programs, the available channel bandwidth should be distributed unevenly among the programs, namely, in proportion to the information content, e.g., that due to the complexity of each of the video sources. Thus, the objective of statistical multiplexing is to dynamically distribute the available channel bandwidth among the video programs in order to maximize the overall picture quality of the system. This is achieved by using a joint rate-control algorithm that guides the operation of the individual encoders based on a continuous monitoring of the scene content of each of the video sources.

Basically, two different approaches can be distinguished for joint rate control: the feedback approach and the look-ahead approach. In the feedback approach, the encoders generate statistical measurements of video complexity as a by-product of the compression process. The statistics from simultaneous segments of all encoders are compared and used to control the bit allocation for the subsequent video. In the look-ahead approach, the complexity statistics are computed by preprocessing all video programs prior to encoding. These statistics are then used to more accurately predict the bit rate allocation needed for optimum compression of the video sources in the rate-distortion sense. Finding the best statistics to describe the complexity of a program is a challenging task. In the feedback approach, the statistics are limited primarily to coding-related parameters. The look-ahead approach provides more freedom of choice, but at the price of extra computational complexity and additional cost. In either case, the main feature of the statistical multiplexing system is that each encoder produces a variable rate bitstream.

It is preferable to use the VBR mode in systems having many encoders, as shown in prior art FIG. 1. In this case the rate of the total bit stream output 14 may be distributed among encoders 18 dynamically, for example, according to desired qualities, such as rate distribution changes from frame to frame. This rate distribution of the total bit stream output 14 among encoders 18 may be realized by an optimization procedure. Such an optimization procedure is referred to as a statistical-multiplexing algorithm. As a result of the application of the statistical-multiplexing algorithm by multiplexer 4, each encoder of the system initiates a bit stream 11, 12, 13 and 19, that changes in bit rate, wherein the total output bit rate is calculated as the sum of the average rates of bit streams 11, 12, 13 and 19 of the constituent encoders. However, in practice, utilization of the statistical-algorithm of multiplexer 4 runs into problems of system support. Turbulence in the output bit stream 14 arises from instability in the encoding-multiplexing-decoding system 27, i.e., because of information loss (for example, loss of either color or frames).

Thus, there is a need to provide a more optimum statistical multiplexing algorithm to overcome turbulence and the deficiencies of system support.

### SUMMARY OF THE INVENTION

Accordingly, it is a principal object of the present invention to overcome the limitations of existing encoding-decoding systems, and to provide improved algorithms for statistical-multiplexed video bit stream control by the optimal distribution of the channel bit-rate among variable bit-rate (VBR) encoders.

It is a further object of the present invention to align the video bit stream with the treatment priorities of the multiplexer inputs.

It is yet a further object of the present invention to vary the encoders' bit rate availabilities as functions of the encoders' output bit rates, aligned with the treatment priorities of the multiplexer's inputs.

A system is provided for statistical-multiplexing, including an algorithm optimized according to the criteria of the output bit stream rate of video encoders. The output bit stream rate is proportional to the treatment rate applied to the multiplexer's input bit stream. Variable bit rate availability for each encoder is defined according to the criteria of the relationship of the desired average rates, as they are distributed among the controlled encoders, with the scanning array of the multiplexer. The desired distribution of the average rates among the controlled encoders, and the multiplexer's scanning array, are fixed in relation to each other.

A method is provided for statistical-multiplexing of the output bit stream data of at least two encoders, wherein the rate and the quality of content of the bit stream data is transmitted over an electronic network between a control computer and at least two encoders, and the bit stream data is multiplexed by at least one multiplexer, wherein the setup parameters of the control computer, encoders and multiplexers is under the control of a human operator, the bit stream data having a statistical distribution of current rates

The method includes monitoring the output bit streams, providing control information by a human operator by assigning priorities to the at least two encoders, limitations of availabilities and scanning arrays. The scanning arrays store the results of monitoring the output bit streams and calculate optimal values including a distribution of bit rates based on any previous transmission and available ranges of bit rates for at least two encoders and an optimal scanning array for at least one multiplexer.

Subsequently the system receives a desired bit rate from the distribution by each of the at least two encoders via the electronic network from the control computer, achieving a resultant desired quality of the content by each of the at least two encoders, based on the desired bit rate. Also included is receiving as input by the control computer via the electronic network from the at least two encoders of information about the current quality of the content concerning the output of the at least two encoders.

Another step involves sending output from the control computer via the electronic network to the at least two encoders, wherein the output carries feedback information about the desired bit-rates. Also the operator sends input information about the at least two encoders' limitations and priorities as defined by the operator. The algorithms provide feedback information to the operator including the optimal ranges of the desired bit rates for each of the at least two encoders, the optimal scanning arrays of the at least one multiplexer, as calculated by an interactive algorithm for the priorities, limitations and scanning arrays. Finally, the system passes feedback information from the interactive algorithm to the algorithm for the optimal distribution of the bit-rates and passes computer information about the scanning arrays to the at least one multiplexer, such that the output bit stream is optimized by having aligned the content of the bit stream with the priorities of the inputs of the at least one multiplexer, and thereby varying the at least two encoders' bit rate availabilities as functions of the at least two encoders' output bit rates, aligned with the priorities of the at least one multiplexer's inputs.

These objects, and others not specified hereinabove, are achieved by an exemplary embodiment of the present invention, wherein an algorithm for statistical-multiplexing is presented as a multi-criteria optimization procedure.

The first criterion is the achieving of a given quality priority distribution. Quality priority refers to the relative qualities of content, such as movies, at the output of the encoders. This feature allows the user to control the distribution of quality among the encoder outputs.

The second criterion consists of adjusting the proportions of the average bit rates to each other, wherein these proportions are constrained to the form of integer-to-integer ratios, e.g., 1:3 but not 1.38:3.15.

The third criterion is the statistical-multiplexing availability limitation. This means that encoders' output bit rates are divided into several classes, wherein a variable bit rate range associated with the encoder output defines each such class. This criterion is optional, and merely attempts to increase the stability of the system.

The fourth criterion requires keeping the overall class average bit rates equal in each class of encoders, thereby assuring that the ratios of the average bit rates to each other remains in the form of integer-to-integer fractions. For example, the average bit rates are 6.5 Mbits/sec, 5 Mbits/sec and 3 Mbits/sec, and the ratio of the average bit rates is 13:10:6.

Another aspect of the present invention consists in alignment of the bit stream on a multiplexer's video output. This alignment provides a laminar output bit stream having a constant inter-proportion of partial bit streams according to their priorities. This aspect is realized by means of a scanning array that controls the internal addressing of the multiplexer to each of its video inputs.

The present invention also modifies the scanning array for the use of cascaded multiplexers, each having a laminar output bit stream.

### BRIEF DESCRIPTION OF THE DRAWINGS

For a better understanding of the invention with regard to the embodiments thereof, reference is made to the accompanying drawings, in which like numerals designate corresponding elements or sections throughout, and in which:

FIG. 1 is a schematic illustration of a prior art multiplexing system;

FIG. 2 is a schematic illustration of an exemplary embodiment of the present invention, showing three encoders having different priorities;

FIG. 3 is a schematic illustration of an exemplary embodiment of the present invention, showing a distribution of the bit rate availabilities limited by the range tolerances;

FIG. 4 is a schematic illustration of an exemplary embodiment of the present invention, showing three encoder groups, wherein all encoders in each group have equal priorities;

FIG. 5 is a schematic illustration of an exemplary embodiment of the present invention, showing two cascaded multiplexers, both of which are addressed to their respective video inputs, in accordance to their respective scanning arrays;

FIG. 6 is a schematic illustration of the exemplary embodiment of the present invention shown in FIG. 3, but showing, by contrast, a short time interval, wherein the tolerances are more flexible; and

FIG. 7 is a system module diagram illustrating the control algorithms of the present invention.

### DETAILED DESCRIPTION OF THE PREFERRED EMBODIMENTS

1. Prior Art System.

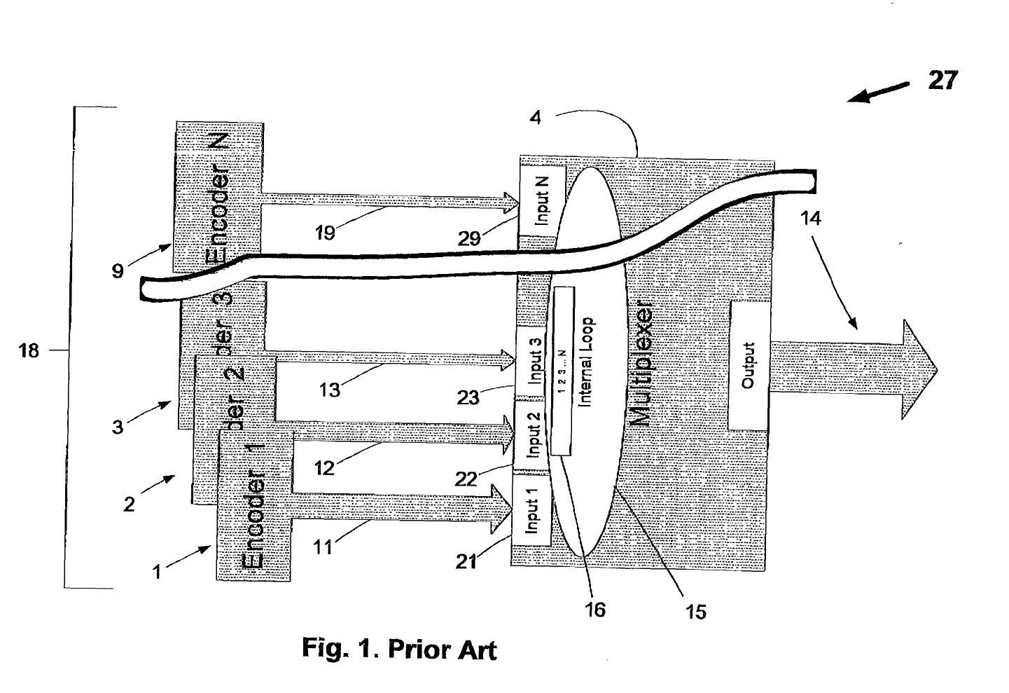

FIG. 1 is a schematic illustration of a prior art multiplexing system 27, that contains N encoders 1, 2, 3, . . . and 9, having output bit streams 11, 12, 13, . . . and 19 respectively, which generally have different bit rates from each other. The bit stream multiplexer 4 treats arriving encoder output bit streams 11, 12, 13, . . . and 19 by sequential addressing to associated inputs: INPUT.index.1 21, INPUT.index.2 22, INPUT.index.3 23, . . . and INPUT.index.9 29, pooling and reading the arriving data. That is, the cyclic sequence is {1, 2, 3, . . . , 9 }. Thus, if the bit rates are unequal, the difference in the bit rates of output bit streams 11, 12, 13, . . . and 19 causes the addressing-pooling-reading process to store delayed bits, because the processing of each of the bit streams does not take an equal amount of time. As a result, the multiplexer output bit stream 14 is not laminar, i.e. does not have uniform periodicity defined by the internal loop 15 of multiplexer 4, in accordance with the simple scanning array 16. A combined transmitting-receiving system, working with such bit stream turbulence, is not stable, i.e. undergoes information loss, for example, loss of either color or frames.

2. Laminar Output Bit Stream and Scanning Array.

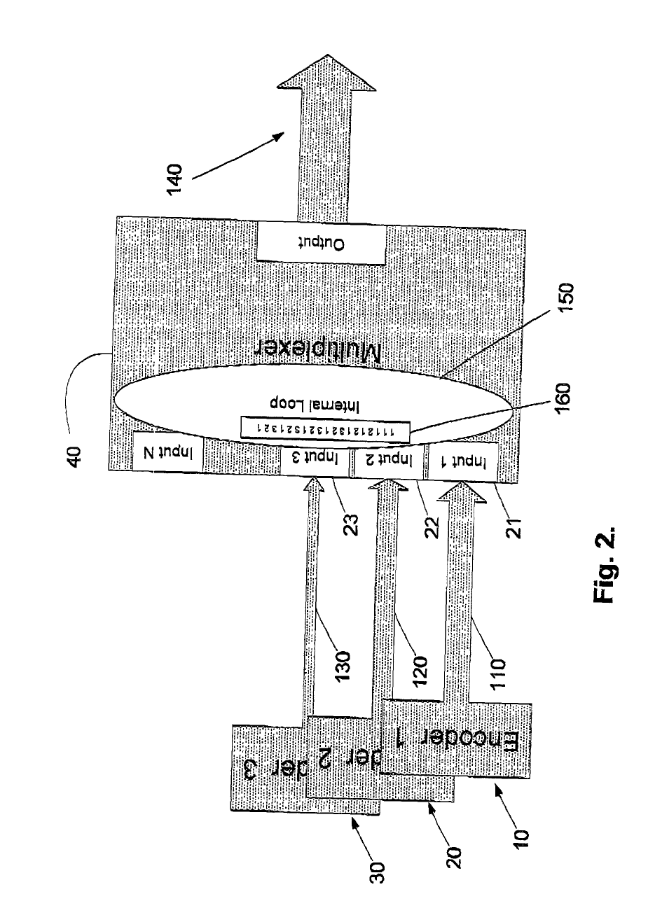

FIG. 2 is a schematic illustration of an exemplary embodiment of the present invention, wherein the three encoders shown have different priorities. The Gold encoder 10 has high priority P.index.h for relative quality, the Bronze encoder 30 has low priority P.index.l for relative quality and the Silver encoder has medium priority P.index.m for relative quality. If all the encoders 10, 20 and 30 treat the same movie, the full video-output rate of channel 140 R.index.Channel is distributed among encoders 10, 20 and 30 as constant bit rates R.index.h, R.index.m and R.index.l respectively, according to the proportion of the priorities, i.e. the proportion R.index.h to R.index.m to R.index.l is the same as the proportion P.index.h to P.index.m to P.index.l. For example, if the bit rates are 6.50 Mbits/sec, 5.00 Mbits/sec and 3.00 Mbits/sec, then the ratio of the average bit rates is 13:10:6.

The bit stream multiplexer 40 treats arriving bit streams 110, 120 and 130 by sequentially addressing the associated inputs: INPUT.index.1 21, INPUT.index.2 22 and INPUT.index.3 23, and by pooling and reading the arriving data. If the proportion P.index.h to P.index.m to P.index.l is represented as a ratio of integers, i.e. as N.gold to N.silver to N.bronze, then bit stream multiplexer 40 addresses associated inputs N.gold, N.silver and N.bronze times, respectively, during the course of its internal loop. For example, if the ratio of the average bit rates is 13:10:6, then N.gold is 13 and is addressed 13 times per loop, N.silver is 10 and is addressed 10 times per loop and N.bronze is 6 and is addressed 6 times per loop. Thus, the cyclic sequence for the scanning array is {1, 1, 1, 2, 1, 2, 1, 2, 1, 2, 1, 3, 2, 1, 3, 2, 1, 3, 2, 1, 3, 2, 1, 3, 2, 1, 3, 2, 1 }.

The addressing-pooling-reading process thereby runs with no storage of delayed bits. As a result, the output bit stream 140 of multiplexer 40 is laminar, i.e. has uniform periodicity defined by the internal loop 150 of multiplexer 40.

Internal loop 150 scans its inputs: INPUT.index.1 21, INPUT.index.2 22 and INPUT.index.3 23 according to a scanning array 160 that consists of a sequence of the input indexes 1, 2 and 3, wherein the index numbers 1, 2 and 3 appear N.gold, N.silver and N.bronze times respectively. Thus, scanning array 160 contains (N.gold+N.silver+N.bronze) input numbers for addressing for each internal loop 150. Obviously, scanning array 160 cannot be arbitrary long, i.e. (N.gold+N.silver+N.bronze) must not be greater than the length, N.piano, of scanning array 160. For the sequence given hereinabove, N.piano was chosen to be equal to 64 and the sum (13+10+6) is equal to 29.

However, the proportion P.index.h to P.index.m to P.index.l cannot always be represented as an integer relation of N.gold to N.silver to N.bronze when N.piano is of specified length. The deviations D.index.h, D.index.m and D.index.l of the proportions are defined as (P.index.h−N.gold), (P.index.m−N.silver) and (P.index.l−N.bronze) respectively. In this case, output bit stream 140 of multiplexer's 40 is not laminar, i.e. does not have uniform periodicity defined by internal loop 140. The distortions of the current laminar output bit stream may require storage, and thus the multiplexing system becomes unstable.

Such a problematic sub-optimal scanning array 160, that is shown in FIG. 2 as an example, provides control of the multiplexed video bit stream alignment for exemplary bit rates R.index.h=8.585, R.index.m=5.672 and R.index.l=3.743, giving a total output bit stream rate of 18 Mbit per sec. A solution of the sub-optimization problem, as an exemplary embodiment of the present invention, consists in finding the numbers N.gold=9, N.silver=6 and N.bronze=4 to minimize the respective deviations D.index.h/N.gold, D.index.m/N.silver and D.index.l/N.bronze, i.e. the priorities P and the integer numbers N are close in value. The proportions P.index.h to P.index.m and to P.index.l are found, on the one hand, equal to proportions of the associated bit rates R.index.h to R.index.m and to R.index.l and, on the other hand, the respective deviations D.index.h/N.gold, D.index.m/N.silver and D.index.l/N.bronze are minimized for maximal length of the scanning array 160 equal, for example, to 64, and the length of the optimal scanning array 160 is equal to 19 in the exemplary embodiment shown in FIG. 2.

3. Direct Inter-Fitting of Priorities and Scanning Array.

In order to guarantee the laminar bit rate stream in a multiplexer's 40 output under the requirement of a constant bit rate, the interposition of priorities with scanning array 160, as an exemplary embodiment of the present invention, is suggested. Such an interposition consists of an additional step of fitting of the initial values of P.index.h, P.index.m and P.index.l to integer values N.gold, N.silver and N.bronze, which are found in the sub-optimal condition concerning the minimization of the respective deviations D.index.h/N.gold, D.index.m/N.silver and D.index.l/N.bronze.

4. Tolerance of the Disproportions and the Statistical-Multiplexing Availability.

The statistical-multiplexing procedure causes the disproportion of the current values of variable output video rates R.gold to R.silver to R.bronze, with reference to the associated current respective priorities P.gold to P.silver to P.bronze, wherein the current respective priorities P.gold to P.silver to P.bronze change in values with the changing of the associated current rates R.gold, R.silver and R.bronze and the sum of P.gold plus P.silver and P.bronze is equal to the sum of N.gold plus N.silver and N.bronze.

When the proportion R.gold to R.silver to R.bronze is not an integer-to-integer-to-integer ratio, i.e. it is not in the same proportion as N.gold to N.silver to N.bronze, the deviations D.gold, D.silver and D.bronze of the proportions are defined as (P.gold−N.gold), (P.silver−N.silver) and (P.bronze−N.bronze) respectively. In this case, the multiplexer's 40 output bit stream is not laminar, i.e. does not have uniform periodicity defined by the multiplexer's 40 internal loop. The distortions of the current laminar output bit stream may cause storage of the residual disproportionality, and thus the statistical-multiplexing system becomes unstable.

The deviations D.gold, D.silver and D.bronze are limited in trade-off capability by the statistical-multiplexing availability defined by the three tolerance values T.gold, T.silver and T.bronze. These three values T.gold, T.silver and T.bronze limit the deviations D.gold, D. silver and D.bronze according to the following conditions:

absolute value of D.gold is not more than T.gold;

absolute value of D.silver is not more than T.silver; and

absolute value of D.bronze is not more than T.bronze, wherein respective tolerances T.gold/N.gold, T.silver/N.silver and T.bronze/N.bronze have values between 0 and 1.

Reducing the statistical-multiplexing availability by decreasing the respective tolerance values T.gold/N.gold, T.silver/N.silver and T.bronze/N.bronze improves system stability. The multiplexing system does not lose its stability, if the following conditions are observed:

The choice of the tolerances T.gold, T.silver and T.bronze is apportioned, providing that the multiplexer output video bit rate is a constant value and, as the result, current sum of the deviations D.gold, D.silver and D.bronze is equal to zero;

Each respective tolerance: T.gold/N.gold T.silver/N.silver T.bronze/N.bronze, is not greater than value Tau found be equal to 0.5, experimentally; and

Each tolerance: T.gold, T.silver and T.bronze, is not greater than the sum of two others (T.bronze+T.silver), (T.gold+T.bronze) and (T.gold+T.silver) respectively.

Thus, the tolerances T.gold, T.silver and T.bronze are inter-dependent values, and the following two relations, as an exemplary embodiment of the present invention, apply:

(N.gold+T.gold)/(N.silver−T.silver) is not greater than {N.gold+Tau*MIN(N.gold, N.silver+N.bronze)}/{N.silver−Tau*MIN(N.gold−N.bronze, N.silver)}and

(N.gold+T.gold)/(N.bronze−T.bronze) is not greater than {N.gold+Tau*MIN(N.gold, N.silver+N.bronze)}/{N.bronze−Tau*MIN(N.gold−N.siver, N.bronze)}

Thus, by giving values Tau and one of the tolerances T.gold, T.silver and T.bronze as initial parameters, the two other tolerance values are defined by these two relations. These two relations represent the inter-dependent limitations of the tolerances T.gold, T.silver and T.bronze, and thereby define the statistical-multiplexing availability for the three encoders 10, 20 and 30. For example, the available tolerance T.bronze may be enlarged by a corresponding reduction of the tolerance T.gold. This further limitation of the statistical-multiplexing availability for the three encoders 10, 20 and 30 becomes a meaningful and helpful degree of freedom in the optimization problem of video bit rate distribution among encoders 10, 20 and 30 according to an exemplary embodiment of the present invention. Optimization is defined as improving the quality of movie coding-decoding, while not decreasing the working stability of the statistical-multiplexing.

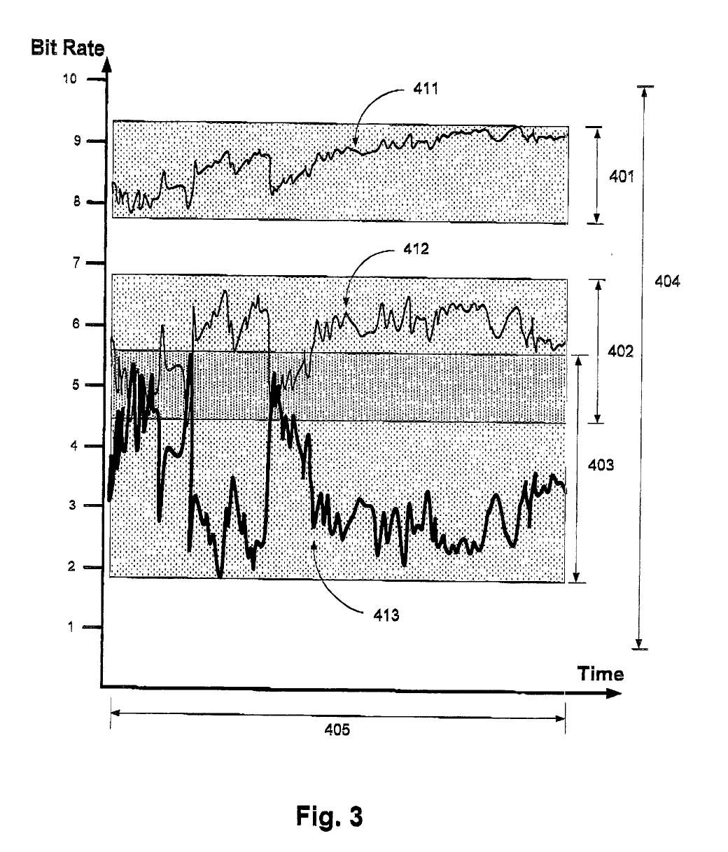

FIG. 3 is a schematic illustration of an exemplary embodiment of the present invention, showing a bit rate availability distribution 404, over a time interval 405, and limited by the tolerance ranges T.gold 401, T.silver 402 and T.bronze 403, which are calculated as described hereinabove, and correspond to encoders 10, 20 and 30 respectively. The curves represent the current variable bit rates R.gold 411, R.silver 412 and R.bronze 413 of encoders 10, 20 and 30 respectively. Bit rate ranges 401, 402 and 403 strictly limit the variable bit rate deviations. The sum of the bit rates of the three encoders is given as equal to 18 Mbit per sec. Exemplary priority proportions P.gold to P.silver to P.bronze are given as 9:6:4, wherein the non-zero bit rate availabilities assume that the desired proportions of the average bit rates A.gold, A.silver and A.bronze for any pre-defined value of time interval 405 may be substantially unsatisfied.

5. Generalization of the Case of Three Encoders to the Case of Three Groups of Encoders.

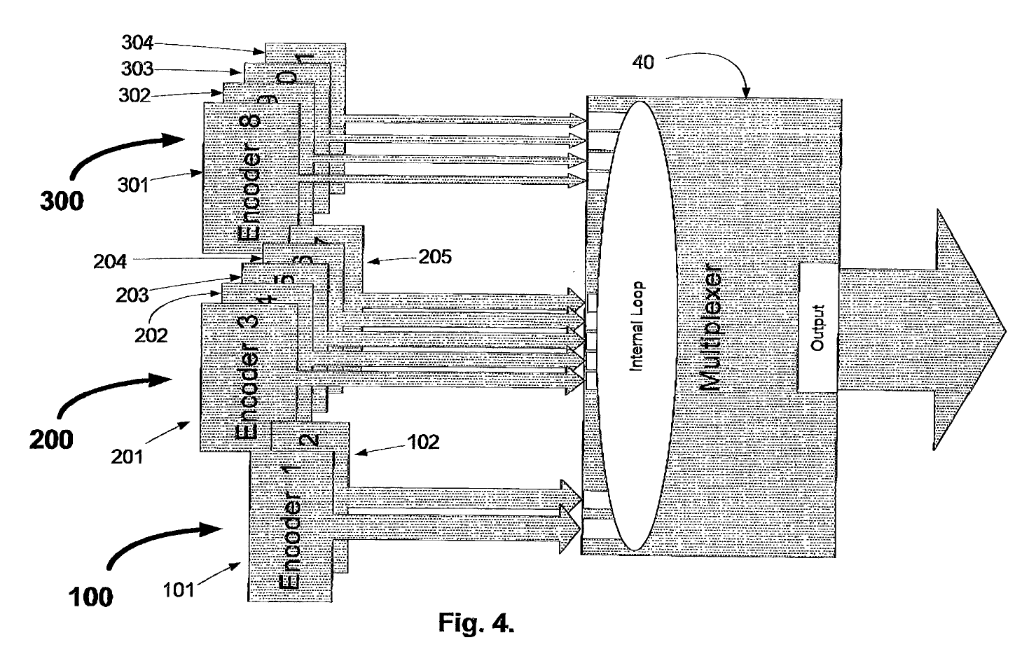

FIG. 4 is a schematic illustration of an exemplary embodiment of the present invention, showing three encoder real groups: 100, 200 and 300. The group 100 contains K.gold=2 encoders 101 and 102 of equal respective real priorities P.gold; the group 200 contains K.silver=5 encoders 201, 202, 203, 204 and 205 of equal respective real priorities P.silver; and the group 300 contains K.bronze=4 encoders 301, 302, 303, and 304 of equal respective real priorities P.bronze. The integer values N.gold, N.silver and N.bronze refer to the associated encoders, and represent the number of times the respective inputs to multiplexer 40 are addressed in each polling loop. The sum of the respective real priorities, is defined, in the exemplary case, as K.gold times of P.gold plus K.silver times of P.silver plus K.bronze times of P.bronze, is equal to (K.gold*N.gold+K.silver*N.silver+K.bronze*N.bronze).

Group priorities P.GOLD, P.SILVER and P.BRONZE are defined for respective generalized group designations GOLD, SILVER and BRONZE, i.e., real groups 100, 200 and 300 in accordance with the following conditions:

P.GOLD=MAX(K.gold*P.gold, K.silver*P.silver, K.bronze*P.bronze)

Consequently, the generalized GOLD group is one of the real groups 100, 200 and 300, having the priority P.GOLD, which comprises the encoders having one of the real priorities P.gold, P.silver or P.bronze, according to the associated maximal value K.gold*P.gold, K.silver*P.silver or K.bronze*P.bronze;

Note that the generalized group designations may be different from the real group designations, because the weight of K, the number of encoders in the group, may outweigh the relative priority P.

P.BRONZE=MIN(K.gold*P.gold, K.silver*P.silver, K.bronze*P.bronze)

Consequently, the generalized BRONZE group is one of the real groups 100, 200 and 300, having the priority P.BRONZE, which comprises the encoders having one of the priorities P.gold, P.silver or P.bronze, according to the associated minimal value K.gold*P.gold, K.silver*P.silver or K.bronze*P.bronze; and

P.SILVER is equal to the medium value among the values K.gold*P.gold, K.silver*P.silver and K.bronze*P.bronze;

Consequently, the generalized SILVER group is one of the real groups 100, 200 and 300, having the priority P.SILVER, which comprises the encoders having one of the priorities P.gold, P.silver or P.bronze, according to the associated medium value K.gold*P.gold, K.silver*P.silver and K.bronze*P.bronze.

Thus the generalized groups GOLD, SILVER and BRONZE, as an exemplary embodiment of the present invention, are interpreted now as generalized encoders GOLD, SILVER and BRONZE having generalized priorities P.GOLD, P.SILVER and P.BRONZE. This generalized case is now equivalent to the simple case illustrated in FIG. 2. If the values T.GOLD, T.SILVER and T.BRONZE are the generalized tolerances, and the integer values N.GOLD, N.SILVER and N.BRONZE are the generalized number of times the multiplexer addresses its generalized inputs, associated respectively with generalized encoders GOLD, SILVER and BRONZE, then the generalized value TAU characterizes the maximal respective generalized tolerance either T.GOLDIN.GOLD T.SILVERIN.SILVER T.BRONZE/N.BRONZE and the following two generalized relations, as an exemplary embodiment of the present invention, take place:

(N.GOLD+T.GOLD)/(N.SILVER−T.SILVER) is not greater than {N.GOLD+TAU*MIN(N.GOLD, N.SILVER+N.BRONZE)}/{N.SILVER−TAU*MIN(N.GOLD−N.BRONZE, N.SILVER)}and

(N.GOLD+T.GOLD)/(N.BRONZE−T.BRONZE) is not greater than {N.GOLD+TAU*MIN(N.GOLD, N.SILVER+N.BRONZE)}/{N.BRONZE−TAU*MIN(N.GOLD−N.SILVER, N.BRONZE)}

Each group GOLD, SILVER and BRONZE consists of several K.GOLD, K.SILVER and K.BRONZE encoders respectively.

TAU is equal to the minimal value among: T.GOLD/N.GOLD; T.SILVER/N.SILVER; and T.BRONZE/N.BRONZE.

6. Definition of Parameters of Grouped Real Encoders.

The real encoders parameters conditionally correlate with the generalized parameters. Reference is now made to six such conditions as exemplary embodiments of the present invention:

1) Condition:

P.GOLD=K.goal*P.gold;

P.SILVER=K.silver*P.silver; and

P.BRONZE=K.bronze*P.bronze.

Wherein

K.GOLD=K.gold;

K.SILVER=K.silver; and

K.BRONZE=K.bronze.

In this case these generalized relations are transformed to real relations by means of replacing the generalized parameters with the following real parameters:

N.GOLD=N.gold*K.GOLD;

T.GOLD=T.gold*K.GOLD;

N.SILVER=N.silver*K.SILVER;

T.SILVER=T.silver*K.SILVER;

N.BRONZE=N.bronze*K.BRONZE; and

T.BRONZE=T.bronze*K.BRONZE.

2) Condition:

P.GOLD=K.silver*P.silver;

P.SILVER=K.gold*P.gold; and

P.BRONZE=K.bronze*P.bronze.

Wherein

K.GOLD=K.silver;

K.SILVER=K.gold; and

K.BRONZE=K.bronze.

In this case these generalized relations are transformed to real relations by means of replacing the generalized parameters with the following real parameters:

N.GOLD=N.silver*K.GOLD;

T.GOLD=T.silver*K.GOLD;

N.SILVER=N.gold*K.SILVER;

T.SILVER=T.gold*K.SILVER;

N.BRONZE=N.bronze*K.BRONZE; and

T.BRONZE=T.bronze*K.BRONZE.

3) Condition:

P.GOLD=K.silver*P.silver;

P.SILVER=K.bronze*P.bronze; and

P.BRONZE=K.gold*P.gold.

Wherein

K.GOLD=K.silver;

K.SILVER=K.bronze; and

K.BRONZE=K.gold.

In this case these generalized relations are transformed to real relations by means of replacing the generalized parameters with the following real parameters:

N.GOLD=N.silver*K.GOLD;

T.GOLD=T.silver*K.GOLD;

N.SILVER=N.bronze*K.SILVER;

T.SILVER=T.bronze*K.SILVER;

N.BRONZE=N.gold*K.BRONZE; and

T.BRONZE=T.gold*K.BRONZE.

4) Condition:

P.GOLD=K.bronze*P.bronze;

P.SILVER=K.gold*P.gold; and

P.BRONZE=K.silver*P.silver.

Wherein

K.GOLD=K.bronze;

K.SILVER=K.gold; and

K.BRONZE=K.silver.

In this case these generalized relations are transformed to real relations by means of replacing the generalized parameters with the following real parameters:

N.GOLD=N.bronze*K.GOLD;

T.GOLD=T.bronze*K.GOLD;

N.SILVER=N.gold*K.SILVER;

T.SILVER=T.gold*K.SILVER;

N.BRONZE=N.silver*K.BRONZE; and

T.BRONZE=T.silver*K.BRONZE.

5) Condition:

P.GOLD=K.bronze*P.bronze;

P.SILVER=K.silver*P.silver; and

P.BRONZE=K.gold*P.gold.

Wherein

K.GOLD=K.bronze;

K.SILVER=K.silver; and

K.BRONZE=K.gold.

In this case these generalized relations are transformed to real relations by means of replacing the generalized parameters with the following real parameters:

N.GOLD=N.bronze*K.GOLD;

T.GOLD=T.bronze*K.GOLD;

N.SILVER=N.silver*K.SILVER;

T.SILVER=T.silver*K.SILVER;

N.BRONZE=N.gold*K.BRONZE; and

T.BRONZE=T.gold*K.BRONZE.

6) Condition:

P.GOLD=K.gold*P.gold;

P.SILVER=K.bronze*P.bronze; and

P.BRONZE=K.silver*P.silver.

Wherein

K.GOLD=K.gold;

K.SILVER=K.bronze; and

K.BRONZE=K.silver.

In this case these generalized relations are transformed to real relations by means of replacing the generalized parameters with the following real parameters:

N.GOLD=N.gold*K.GOLD;

T.GOLD=T.gold*K.GOLD;

N.SILVER=N.bronze*K.SILVER;

T.SILVER=T.bronze*K.SILVER;

N.BRONZE=N.silver*K.BRONZE; and

T.BRONZE=T.silver*K.BRONZE.

7. Cascading of Multiplexers.

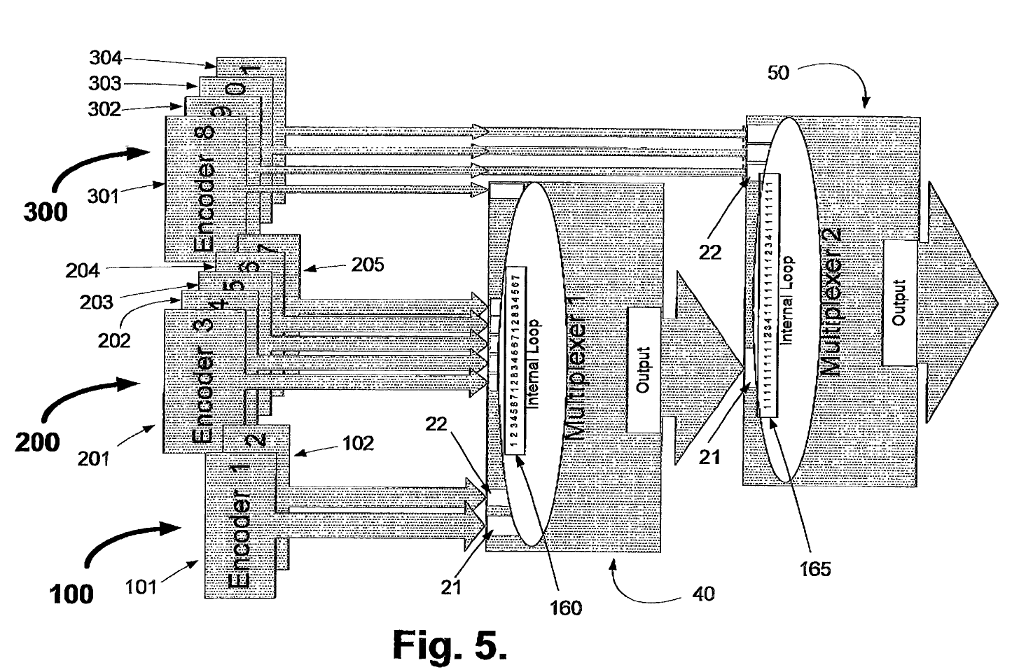

FIG. 5 is a schematic illustration of an exemplary embodiment of the present invention, showing two cascaded multiplexers 40 and 50, both of which are addressed to their respective video inputs: INPUT.index.1 21, INPUT.index.2 22, etc., in accordance with their respective scanning arrays. In the case of cascaded multiplexers, scanning arrays 160 and 165 of respective multiplexers 40 and 50 are constructed such that the two scanning arrays 160 and 165 provide laminar bit rate streams on the output of each multiplexer. The proportions P.gold to P.silver to P.bronze are found, on the one hand, to be equal to the proportions of the associated bit rates R.gold to R.silver to R.bronze. On the other hand, the respective deviations D.index.h/N.gold, D.index.m/N.silver and D.index.l/N.bronze are minimized (i.e. the priorities P and the integer numbers N are close in value) for the number of encoders greater than the number of the multiplexer's inputs and maximum lengths of the scanning arrays 160 and 165 are equal, for example, to 64.

8. Optimization According to the Criterion of the Given Inter-Proportions of Average Rates.

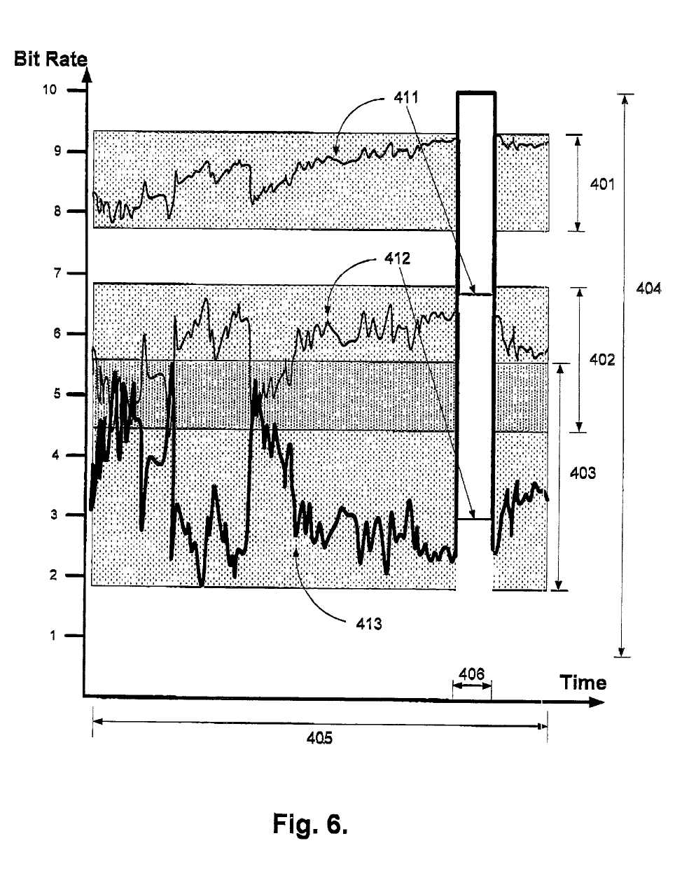

FIG. 6 is a schematic illustration of an exemplary embodiment of the present invention shown in FIG. 3, but showing, by contrast, a short time interval, wherein the tolerances are more flexible. A distribution of the bit rate availabilities 401, 402 and 403, is calculated as described hereinabove, where the bit rate ranges 401, 402 and 403 refer to the encoders 10, 20 and 30 respectively. The curves 411, 412 and 413 refer to the variable bit rates of encoders 10, 20 and 30 respectively.

In contrast to the exemplary embodiment, shown in FIG. 3, the bit rate ranges 401, 402 and 403 do not substantially limit the variable bit rate changes. There is a short time interval 406 in every time period 405, when the limitations 401, 402 and 403 are ignored, and only the limitation 404 applies, which is a property of the encoders. This degree of freedom is utilized for aligning the given proportions P.gold to P.silver to P bronze for the average bit rates A.gold, A.silver and A.bronze, and, thereby, for increasing the stability of the encoding-multiplexing-decoding system. In practice, the short time interval 406 is chosen to be less than 0.5 second; therefore any momentary disturbance of the movies' quality continuity is imperceptible.

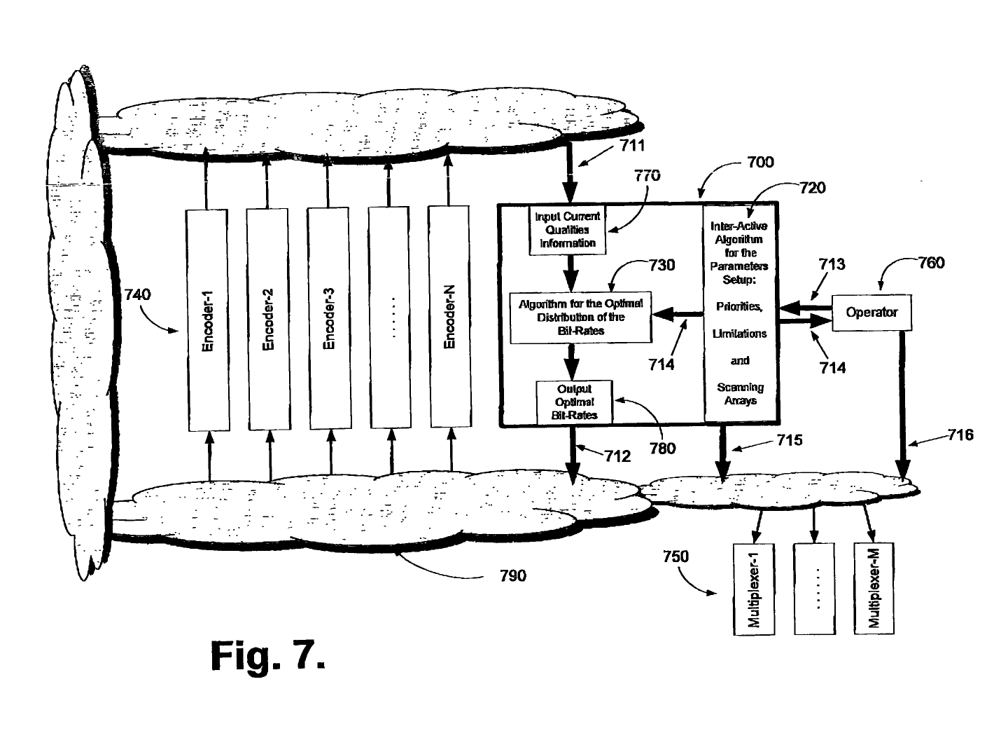

FIG. 7 is a system module diagram illustrating the control algorithms of the present invention. Block 700 is the control computer, which is included in the Internet network 790, along with the systems' components: a set of encoders 740 and cascaded multiplexers 750. There are no bit-streams in the block diagram. Only connections to Internet 790 are shown. In an exemplary embodiment of the present invention, User Datagram Protocol (UDP) is utilized. UDP is a connectionless protocol, which, like TCP/IP, is layered on top of IP.

UDP is a set of protocols comprising the Internet standard network layer, transport layer and session layer, which provide simple but unreliable datagram services. A datagram is a self-contained, independent entity of data carrying sufficient information to be routed from the source to the destination computer with reliance neither on earlier exchanges between this source and destination computer nor on the transporting network. UDP neither guarantees delivery nor does it require a connection. As a result it is lightweight and efficient, but all error processing and retransmission must be taken care of by the application program.

Block 720 is the Inter-Active Algorithm for Parameter Setup: Priorities, Limitations and Scanning Arrays. Algorithm 720 calculates the optimal bit-rate ranges for gold, silver and bronze encoders 740, and the optimal scanning arrays for cascaded multiplexers 750.

Block 730 is the algorithm for the Optimal Distribution of the Bit-Rates (Statistical-Multiplexing Algorithm). Said algorithm calculates the current optimal distribution of the bit-rates, wherein the said distribution depends on all movies' qualities achieved on associated encoders by means of controlled bit-rates on the previous sending.

Block 740 is the set of encoders that are to be controlled. Each encoder 740 receives the value of the desired bit-rate to achieve a resultant quality, with the intention of getting closer to the desired quality, from statistical-Multiplexing Algorithm block 730 via Internet 790, provides the video compression to achieve the desired resultant quality and returns to Statistical-Multiplexing Algorithm 730 the information about that resultant quality.

The cascade 750 of multiplexers is arranged when there are more encoders than the number of inputs to a multiplexer. i.e., there may be more than one multiplexer.

Block 760 illustrates the human operator. The operator, in block 760, provides control system operation, by defining the encoders' parameter limitations and assigning priorities and methods of operation to the encoders.

Block 770 is the input to the control computer from Internet 790 via encoder output 711, that carries information about the current quality of each movie on the output of the corresponding encoder 740.

Block 780 is the output from the control computer to Internet 790 via encoder input 712, that carries feedback information about the desired bit-rates.

Operator input information 713 is provided about the encoders' limitations and priorities (Gold, Silver and Bronze), as defined by operator 760. Feedback information 714 is provided to operator 760 about the desired bit-rate ranges of the gold, silver and bronze encoders 740 and the scanning arrays of the cascaded multiplexers 750, as calculated by Inter-Active Algorithm for the Parameters Setup in block 720.

Feedback information 714 is also passed to the algorithm for the optimal distribution of the bit-rates (Statistical-Multiplexing Algorithm) 730.

Computer information 715 about the scanning arrays is passed directly to cascaded multiplexers 750. Operator output information 716 is passed from operator 760 to cascaded multiplexers 750, whereby, in the general case, there may be the information about scanning arrays, extracted from feedback information 714, and passed on as operator output information 716.

Having described the invention with regard to certain specific embodiments thereof, it is to be understood that the description is not meant as a limitation, since further modifications may now suggest themselves to those skilled in the art, and it is intended to cover such modifications as fall within the scope of the appended claims.

We claim:

1. A system for statistical-multiplexing of bit stream data under control of human operator, said system having a statistical distribution of average rates, said system comprising:
a plurality of bit stream encoders arranged in groups, each of said groups having a different bit rate range for compression of content for transmission over an electronic network, each encoder having an assigned priority for processing said bit stream data;
a control computer configured to receive as input, the resulting current quality of content relative to output bit-streams of said plurality of encoders, and configured to send as output, the calculated desired bit-rates for said plurality of encoders; and
a plurality of cascaded multiplexers coupled via an electronic network to receive from said control computer a scanning array for storing the results of monitoring said output bit streams,
said control computer being programmed to control said plurality of bit stream encoders, thereby defining the relative quality of the output of said plurality of encoders.

2. The system of claim 1, wherein a desired distribution of the average bit stream rates among said plurality of encoders is fixed in alignment with said priorities, as determined by said scanning array of said plurality of cascaded multiplexers.

3. The system of claim 1, wherein said scanning array of said plurality of cascaded multiplexers is fixed in alignment according to a desired distribution of the average bit stream rates among said plurality of encoders.

4. The system of claim 1, wherein a desired distribution of the average bit stream rates among said plurality of encoders and in relation to said scanning array of said plurality of cascaded multiplexers are fixed in alignment with each other.

5. The system of claim 1, wherein a desired distribution of the average bit stream rates among said plurality of encoders is kept for a pre-defined time interval.

6. The system of claim 1, wherein the bit stream rates vary within limits defined by a criterion of alignment of a desired distribution of the average bit stream rates among said plurality of encoders and in relation to said scanning array of said plurality of cascaded multiplexers, whereby said limits determine available ranges of bit rates.

7. The system of claim 6, wherein each of said plurality of encoders is used for encoding content, and wherein said available variation of bit stream rates for each of said plurality of encoders is defined according to the relative quality of said content among said plurality of encoders, said relative quality being defined by said assigned priorities.

8. The system of claim 1, wherein said electronic network is the Internet.

9. A method for statistical-multiplexing of the output bit stream data of a plurality of encoders arranged in groups, wherein the bit rate and the quality of content of said bit stream data is transmitted over an electronic network between a control computer and said plurality of encoders, and said bit stream data is multiplexed by plurality of cascaded multiplexers, wherein the interface for setup parameters, of said plurality of encoders and said plurality of cascaded multiplexers is under the control of a human operator via said control computer, said bit stream data having a statistical distribution of current rates, and said method comprising:
monitoring said output bit streams;
providing control information by said human operator by assigning priorities to said plurality of encoders, limitations of availabilities and scanning arrays, said scanning arrays storing the results of monitoring said output bit streams;
calculating optimal values comprising:
distribution of bit rates based on any previous transmission; and
available ranges of bit rates for said plurality of encoders and optimal scanning arrays for said plurality of cascaded multiplexers;
receiving of said bit rates from each of said encoders via said electronic network from said control computer;
achieving a resultant desired quality of said content by each of said encoders, based on said desired bit rate;
receiving as input by said control computer, via said electronic network, from said plurality of encoders, said input comprising information about the current quality of said content concerning the output of said plurality of encoders;
sending output from said control computer via said electronic network to said plurality of encoders, said output carrying feedback information about said desired bit-rates;
sending operator input information about said plurality of encoders' limitations and priorities as defined by said operator;
providing feedback information to said operator comprising:
the optimal ranges of said desired bit rates for each of said plurality of encoders; and
said optimal scanning arrays of said plurality of cascaded multiplexers, as calculated by an interactive algorithm for said priorities, limitations and scanning arrays;
passing feedback information from said interactive algorithm to said algorithm for the optimal distribution of said bit-rates; and
passing computer information about said scanning arrays to said plurality of cascaded multiplexers,
such that said output bit stream is optimized by having aligned said content of said bit stream with said priorities of said inputs of said plurality of cascaded multiplexers, and thereby varying said plurality of encoders' bit rate availabilities as functions of said plurality of encoders' output bit rates, aligned with said priorities of said plurality of cascaded multiplexer'sinputs.

10. The method of claim 9, wherein each of said cascaded multiplexers has its own associated scanning array.

11. The method of claim 9, wherein said plurality of encoders are separated into at least two groups, wherein each group has an associated optimal available range of bit rates for an associated priority.
